(19) United States
(12) Patent Application Publication
(10) Pub. No.: US 2014/0267712 A1
(43) Pub. Date: Sep. 18, 2014

(54) THEFT ALERT SYSTEM FOR ELECTRIC VEHICLE CHARGING CABLE

(71) Applicant: Eaton Corporation, (US)

(72) Inventors: Andrew Jay Foerster, Wexford, PA (US); Todd N. Butler, Williamsburg, VA (US); Jason Okerman, Moon Township, PA (US); David Austin Eldridge, Knoxville, TN (US)

(21) Appl. No.: 13/842,558

(22) Filed: Mar. 15, 2013

(51) Int. Cl. G08B 13/14; H04N 7/18

(52) U.S. Cl. CPC G08B 13/1445; H04N 7/188
USPC 348/143; 340/568.3

(57) ABSTRACT

A charging cable theft warning system includes a charging cable, a connector coupled to the charging cable, an ECU, at least one sensor configured to detect tampering with the charging cable, and an alert system configured to provide an alert corresponding to the at least one sensor detecting a tampering. A sensor may include a quick-disconnect coupling and/or may be configured to monitor an electrical characteristic of the system. A sensor may, additionally or alternatively, include one or more of a holster, a signal transceiver, and a communication device. The alert may include an audible alert, a visual alert, and/or a signal transmitted to a remote location. The system may also include a camera.

### TECHNICAL FIELD

The present teachings relate to theft alert systems, including an alert system that indicates potential tampering or theft of an electric vehicle charging cable.

### BACKGROUND

In recent years, plug-in electric vehicles and hybrid vehicles (collectively “plug in vehicles” or “PHVs”) having rechargeable batteries are becoming more popular. PHV batteries may be recharged via a charging cable that connects the vehicle battery to a power supply. The charging cable may contain large copper conductors that carry electricity from the charging station to the battery.

Prolonged, unattended charging in public outdoor locations will be more common as electric vehicles gain popularity. Since charging cables may each contain several pounds of valuable material, such as copper, the cables are vulnerable to theft, particularly as salvage prices for component materials increase.

### SUMMARY

A charging cable theft warning system in accordance with an embodiment of the present disclosure includes a charging cable, a connector coupled to the charging cable, an ECU, at least one sensor configured to detect tampering with the charging cable, and an alert system configured to provide an alert corresponding to the at least one sensor detecting a tampering. In an embodiment the system may include a coupling connecting the charging cable to the charging station. The at least one sensor may include a switch disposed in the coupling. The coupling may include a quick-disconnect coupling.

In an embodiment, the at least one sensor may be configured to monitor an electrical characteristic of the system, which may include an electrical current of one or more conductors of the charging cable.

In an embodiment, the at least one sensor may be configured to provide an electrical current to at least one conductor of the charging cable and/or may include an electrical conversion device including at least one rectifier and at least one filter. In an embodiment, the at least one sensor may include a holster that may include at least one resistive element.

In an embodiment, the at least one sensor may comprise a signal transceiver configured to send a signal through the charging cable. The ECU and/or the at least one sensor may be configured to detect an impulse reflection time of the signal. The ECU, the at least one sensor, and/or the alarm system may be configured to monitor the impulse reflection time and generate an alert when the impulse reflection time is outside of an expected range. The signal transceiver may include a time domain reflectometer.

In an embodiment, the at least one sensor may include a communication device, which may include at least one wireless transmitter. The at least one wireless transmitter may be disposed in the connector and may include a cellular transmitter. In an embodiment, the at least one sensor may include a GPS device and/or an RFID device at least partially disposed in the connector. In an embodiment, the alert may include at least one of an audible alert, a visual alert, and an alert signal transmitted to a remote location. In an embodiment, the system may include a camera configured to take at least one picture and/or record video of an area at or near the system.

### BRIEF DESCRIPTION OF THE DRAWINGS

FIG. 1 generally illustrates an embodiment of a charging cable theft warning system including a first sensor and in accordance with the teachings of this disclosure.

FIG. 2 generally illustrates an embodiment of a charging cable theft warning system including a second sensor and in accordance with the teachings of this disclosure.

FIG. 3 generally illustrates an embodiment of a charging cable theft warning system including a third sensor and in accordance with the teachings of this disclosure.

FIG. 4 generally illustrates an embodiment of a charging cable theft warning system including a fourth sensor and in accordance with the teachings of this disclosure.

FIG. 5 generally illustrates an embodiment of a charging cable theft warning system including a fifth sensor and in accordance with the teachings of this disclosure.

FIG. 6 generally illustrates an embodiment of a charging cable theft warning system including a sixth sensor and in accordance with the teachings of this disclosure.

FIGS. 7A and 7B generally illustrates embodiments of a charging cable theft warning system including a seventh sensor and in accordance with the teachings of this disclosure.

FIG. 8 generally illustrates an embodiment of an alarm system of a charging cable theft warning system and in accordance with the teachings of this disclosure.

### DETAILED DESCRIPTION

FIG. 1 generally illustrates an embodiment of a charging cable theft warning system 10. System 10 may include a PHV charging station 12 with a charging cable 20 that may connect the charging station 12 to a vehicle 30 via a connector 26, such as, without limitation a plug and/or a J1772 coupler. As generally shown in FIG. 1, an embodiment of system 10 may include one or more sensors (e.g., first sensor 100), and each sensor may be configured to detect a charging cable 20 disconnection or tampering. Charging station 12 may include an electronic control unit (ECU) 18. System 10 may be connected to and/or include an energy source 14.

ECU 18 may comprise a programmable microprocessor and/or microcontroller, and/or may include, for example, an application specific integrated circuit (ASIC). ECU 18 may include a central processing unit (CPU), memory, and/or an input/output (I/O) interface. ECU 18 may be configured to perform various functions, including those described in greater detail herein, with appropriate programming instructions and/or code embodied in software, hardware, and/or other medium.

As generally illustrated in FIG. 2, ECU 18 may include one or more electrical components. For example, and without limitation, ECU 18 may comprise one or more relays 40, voltage detectors 42A, 42B, 42C, electronic switches 44, logic gates 46, signal generators 48, resistive elements (e.g. resistive element 50A), controllers 52, and/or other desired electrical component(s). In an embodiment, for example, and without limitation, resistive element 50A may provide a resistance of 1,000 ohms. In an embodiment, one or more of voltage detectors 42A, 42B, 42C may include operational amplifiers.

Cable 20 may include a plurality of conductors. The conductors may comprise copper and/or other conducting materials. In an embodiment, the plurality of conductors may comprise four conductors, which may include a first power conductor 20A, a second power conductor 20B, a ground conductor 20C, and a pilot conductor 20D. In an embodiment, cable 20 may include a fifth conductor, which may include proximity conductor 20E. First and second power conductors 20A, 20B may, for example, be configured to provide electrical energy to a vehicle 30. Ground conductor 20C may, for example, be connected to an electrical ground (e.g., electrical ground 28). Proximity conductor 20E may, for example, be configured to allow the vehicle to detect the presence of connector 26.

Connector 26 may include one or more electrical components. For example, and without limitation, connector 26 may include switches 54, resistive elements (e.g., resistive elements 50B and 50C), and/or other desired electrical component(s). In an embodiment, resistive element 50B may, for example and without limitation, provide a resistance of about 150 ohms and/or resistive element 50C may provide a resistance of about 330 ohms.

Vehicle 30 may be configured to be coupled to connector 26, and may be configured to at least partially receive connector 26. Vehicle 30 may include a charging circuit 36 and/or electrical components, such as, without limitation resistive elements 50D, 50E, 50F, 50G, diode 56, voltage detector 42D, controller 52B, relay 40B, and/or other desired electrical component(s). For example, and without limitation, in an embodiment, resistive element 50D may provide a resistance of about 2,700 ohms, resistive element 50E may provide a resistance of about 330 ohms, resistive element 50F may provide a resistance of about 2,740 ohms, and/or resistive element 50G may provide a resistance of about 1,300 ohms.

As generally illustrated in FIG. 1, an embodiment of system 10 may comprise a first sensor 100 configured to detect a charging cable 20 disconnection. First sensor 100 may comprise a connection sensor 102 that may be monitored, for example, by ECU 18 in charging station 12. Connection sensor 102 may be disposed at a junction 24 between charging cable 20 and charging station 12, such as in a coupling 22, which may be a quick-disconnect coupling. In an embodiment, connection sensor 102 may comprise a switch 104, which may be a micro switch, disposed in coupling 22. Connection sensor 102 may have a first state and a second state. In an embodiment, the first state may correspond to cable 20 being connected with system 10 via coupling 22, and the second state may correspond to cable 20 being disconnected from system 10. If a threshold force is applied to cable 20, coupling 22 may disengage and allow cable 20 to be decoupled from station 12. If coupling 22 disengages, connection sensor 102 may change from the first state to the second state. ECU 18 may be configured to monitor the change in state of connection sensor 202 and detect a disconnection.

As generally illustrated in FIG. 2, in an embodiment, system 10 may, additionally or alternatively, comprise a second sensor 200 that may be at least partially disposed in charging cable 20 to detect if cable 20 is severed, tampered with, and/or cut. In an embodiment, second sensor 200 may include, for example, and without limitation, a conductor 204, an electrical characteristic sensor 206, an energy source 208, and/or resistive elements 212, 214.

Conductor 204 may be embedded along a least a portion of the length of charging cable 20. In an embodiment, conductor 204 may comprise a dedicated loop embedded in cable 20 and/or may at least partially comprise proximity conductor 20E. Conductor 204 may be connected to electrical characteristic sensor 206, a power source 208, an electrical ground 28, ECU 18, and/or an alert system 60. Second sensor 200 may be connected to electrical ground 28 via ground conductor 20C, which may be connected to or at least partially disposed in connector 26. Electrical characteristic sensor 206, which may be referred to as sensor 206, may be configured to sense and/or detect one or more electrical characteristics of system 10, such as, without limitation, current, voltage, and/or resistance. For example, and without limitation, electrical characteristic sensor 206 may be configured to sense a voltage drop across resistive element 212.

As generally illustrated in FIG. 2, in an embodiment, ECU 18 may include at least a portion of second sensor 200. However, in an embodiment, sensor 200 may be disposed apart from ECU 18 and may be connected to ECU 18 by various known wired and/or wireless means.

Energy source 208 may be configured to provide electrical energy to conductor 204 and/or sensor 206 such that current may pass through conductor 204 and/or sensor 206 to ground 28. If charging cable 20 is tampered with, an electrical characteristic sensed and/or detected by sensor 206 may be altered. For example, and without limitation, sensor 206 may be configured to sense and/or detect a voltage drop across resistive element 212. Under normal circumstances (e.g., when cable 20 has not been tampered with), sensor 206 may monitor a voltage drop across resistive element 212, which may be relatively small, such as, without limitation, on the order of about tens of millivolts. If sensor 206 senses that the voltage drop across resistive element 212 is zero, ECU 18 and/or second sensor 200 may detect that cable 20 has been tampered with.

As generally illustrated in FIG. 3, in an embodiment, system 10 may, additionally or alternatively, include a third sensor 300. A third sensor 300 may include, for example, and without limitation, at least a portion of pilot conductor 20D and/or ground conductor 20C, an electrical characteristic sensor 304, an electrical conversion device 306, and a resistive element 308. Third sensor 300 may be connected to ECU 18. For example, and without limitation, third sensor 300 may be connected across resistive element 50A.

Electrical conversion device 306 may comprise an operational amplifier, a rectifier, and/or a filter and may be configured to convert an alternating current (AC) to a direct current (DC). Electrical characteristic sensor 304 may be connected to electrical conversion device 306 and may be configured to monitor, sense, and/or detect an electrical characteristic of ECU 18, such as, without limitation, a voltage drop across resistive element 50A.

In an embodiment, resistive element 308 may be disposed in connector 26 and may be connected to pilot conductor 20D and an electrical ground 28, which may be via ground conductor 20C. Resistive element 308 may be configured to provide a sufficiently high resistance to avoid interfering with the normal function of system 10. For example, and without limitation, resistive element 308 may be configured to provide a resistance of about ten times larger or more than the resistance associated with 50F.

For example, and without limitation, third sensor 300 may monitor a voltage drop across an electrical component of ECU 18, such as resistive element 50A. Under normal circumstances (e.g., when cable 20 has not been tampered with), third sensor 300 may monitor a voltage drop across resistive element 50A, which may be relatively small, such as, without limitation, on the order of about tens of millivolts. If third sensor 300 senses that the voltage drop across resistive element 50A is zero, third sensor 300 may detect that cable 20 has been tampered with. ECU 18 may be configured to monitor third sensor 300 to detect the tampering and/or third sensor 300 may be connected to alert system 60.

As generally illustrated in FIG. 4, in an embodiment, system 10 may, additionally or alternatively, comprise a fourth sensor 400 that may monitor the presence of cable 20 via a holster 402. Holster 402 may be configured to provide a similar response to that of vehicle 30 when cable 20 is connected to vehicle inlet 32. For example, holster 402 may comprise a diode 404 and/or a resistive element 406. Diode 404 and/or resistive element 406 may be configured to be connected to pilot conductor 20D if cable 20 is coupled to holster 402. Cable 20 may be configured to be coupled to holster 402 via connector 26. Resistive element 406 may provide generally the same resistance as vehicle inlet 32. For example, and without limitation, resistive element 406 may provide a resistance of about 2,740 ohms.

ECU 18 may be configured to monitor cable 20 and/or connector 26 to determine if cable 20 is connected to resistive element 406 and/or diode 404. For example, and without limitation, fourth sensor 400 may include an electrical characteristic sensor 408, and/or an electrical conversion device 410. Electrical conversion device 410 may comprise an operational amplifier, a rectifier and/or a filter, and may be configured to convert an alternating current (AC) to a direct current (DC). Electrical characteristic sensor 408 may be connected to electrical conversion device 410 and may be configured to monitor, sense, and/or detect an electrical characteristic of ECU 18, such as, without limitation, a voltage drop across resistive element 50A.

For example, and without limitation, in an embodiment, fourth sensor 400 may monitor a voltage drop across an electrical component of ECU 18, such as resistive element 50A. If cable 20 is coupled with holster 402 via connector 26, a voltage drop across resistive element 50A may exist because pilot conductor 20D may be connected to ground 28 via resistive element 406 and/or diode 404. The voltage drop across resistive element 50A may comparatively be relatively small, such as, without limitation, on the order of about tens of millivolts. Fourth sensor 400 may monitor the voltage drop across resistive element 50A. If cable 20 is decoupled from holster 402 and/or if cable 20 is tampered with, pilot connector 20D may be disconnected from ground 28, which may cause the voltage drop across resistive element 50A to become zero. If fourth sensor 400 senses that the voltage drop across resistive element 50A is zero, fourth sensor 400 may detect that cable 20 may not be coupled to holster 402.

ECU 18 may be configured to monitor fourth sensor 400 to detect a tampering and/or fourth sensor 400 may be connected to an alert system 60. ECU 18 may detect a disconnection if cable 20 is not connected to vehicle inlet 32 or holster 402 for more than a connection threshold time. The connection threshold time may correspond to an expected amount of time to move cable 20 from holster 402 to vehicle inlet 32 or from vehicle inlet 32 to holster 402. For example, and without limitation, the connection threshold time may be about 20 seconds to allow a user to move cable 20 from charging station 12 to vehicle inlet 32. If the threshold time is exceeded, for example if cable 20 is tampered with, severed, or cut, ECU 18 may detect the tampering and/or disconnection. If cable 20 is reconnected to holster 402 or vehicle inlet 32 after the threshold time has elapsed, ECU 18 may be configured to detect the reconnection. There may also be a plurality of connection threshold times. For example, and without limitation, ECU 18 may detect a possible disconnection after a first connection threshold time and may detect a more definite disconnection after a longer second connection threshold time.

Holster 402 may be physically connected to charging station 12 or may be separated from charging station 12. Holster 402 may also be configured to receive at least a portion of connector 26, and, additionally or alternatively, connector 26 may be configured to receive at least a portion of holster 402. Holster 402 may include a device or switch (e.g., switch 412) configured to detect the presence of connector 26. Connector 26 may be configured to be physically connected with holster 402 and/or may be connected without direct physical contact.

Additionally or alternatively, in an embodiment, holster 402 may provide a different response than vehicle inlet 32. For example, and without limitation, resistive element 406 may provide a resistance less than or greater than vehicle inlet 32. ECU 18 and/or fourth sensor 400 may be configured to sense the resistance of resistive element 406 if cable 20 is connected to holster 402. ECU 18 and/or fourth sensor 400 may be configured to determine, based on the sensed resistance, whether connector 20 is connected to holster 402, connected to vehicle inlet 32, or not connected to either.

As generally illustrated in FIG. 5, in an embodiment, system 10 may, additionally or alternatively, comprise a fifth sensor 500. Fifth sensor 500 may include an transceiver 502 configured to transmit a signal through charging cable 20. Signal transceiver 502 and/or ECU 18 may be configured to monitor the amount of time before the signal is reflected back to sensor 500. Signal transceiver 502 may comprise a time domain reflectometer and/or may use time domain reflectometry (TDR) to determine the length of cable 20. The length of cable 20 may correspond to the amount of time before the transmitted signal is reflected back. ECU 18 and/or signal transceiver 502 may then compare the reflection time with an expected time. If the signal is reflected early (i.e., the reflection time is shorter than the expected time), ECU 18 and/or fifth sensor 500 may detect that charging cable 20 is has become shorter, which may indicate that cable 20 has been cut. As generally illustrated in FIG. 5, fifth sensor 500 may be at least partially included in ECU 18.

Signal transceiver 502 may be configured to transmit a signal through charging cable 20 at all times and/or may be configured to transmit a signal intermittently and/or under certain conditions. For example, and without limitation, electronic switch 504 may be configured to permit signal transceiver 502 to transmit a signal through charging cable 20 when cable 20 is not connected to a vehicle 34. Electronic switch may 504 may also be configured to permit signal generator 48 to transmit a signal through charging cable 20 when cable 20 is connected to a vehicle 34.

As generally illustrated in FIG. 6, in an embodiment, system 10 may, additionally or alternatively, comprise a sixth sensor 600. Sixth sensor 600 may include communication device 602, an electrical characteristic sensor 604, a battery 606, and/or a battery charger 608. Communication device 602 may include a transmitter, a receiver, and/or a transceiver. Communication device 602 may be configured to communicate via a network, which may include a cellular network, radio-frequency identification (RFID) communication, Bluetooth communication, and/or any other desired wireless or at least partially wireless network and/or communication. Communication device 602 may include an antenna 618.

Sixth sensor 600 may comprise an energy storage component 606, such as, without limitation, a battery, which may be configured to provide energy for sixth sensor 600. System 10 may be configured to provide energy to energy storage component 606 when connector 26 is coupled with system 10 (e.g., when cable 20 has not been severed, tampered with, and/or cut). For example, and without limitation, system 10 may provide a trickle charge to energy storage component 606 via pilot conductor 20D. Sixth sensor 600 may include an energy storage component charger 608, which may be a battery charger.

Sixth sensor 600 may, additionally or alternatively, include a global positioning system (GPS) device 610. GPS device 610 may be configured to acquire and/or provide GPS related data. The GPS data may correspond to a GPS location of connector 26 and/or cable 20. For example, and without limitation, communication device 602 may be configured to communicate the GPS location of a stolen connector 26 and/or a stolen cable 20 to a remote location 612 via a cellular network. Cellular device 602 may include at least a portion of GPS device 610.

Sixth sensor 600 may be configured to monitor an electrical characteristic of system 10. For example, and without limitation, electrical characteristic sensor 604 may be configured to sense, detect, and/or monitor a voltage of one or more conductors of cable 20 (e.g., pilot conductor 20D).

Communication device 602, electrical characteristic sensor 604, energy storage device 606, energy storage device charger 608, and/or GPS device 610 may be coupled to a circuit board 612.

Sixth sensor 600 may be configured to detect if cable 20 is altered (e.g., disconnected, tampered with, severed, etc.). For example, and without limitation, in an embodiment under normal conditions (e.g., when cable 20 has not been altered), one or more conductors of cable 20 may provide a voltage that may be sensed, detected, and/or monitored by electrical characteristic sensor 604. If cable 20 is altered, a voltage of cable 20 may change and/or may be reduced to zero. Sixth sensor 600 may be configured to detect the alteration if a voltage of cable 20 changes and/or becomes zero.

Sixth sensor 600 may be configured to cause communication device 602 to place a cellular phone call and/or transmit data via a network. The cellular phone call may be made and/or the data may be transmitted to a remote location 86 that may be a monitoring service 88, which may be cloud-based. Monitoring service 88 may be configured to notify an owner of station 12, a law enforcement agency, and/or any other desired person, group of people, or device. Communication device 602 may be configured to communicate via a network on a regular basis, for example, to confirm the presence and/or location of cable 20. Additionally or alternatively, communication device 602 may be configured to communicate if sixth sensor 600 detects an alteration associated with a cable 20 or system.

As generally illustrated in FIGS. 7A and 7B, in an embodiment, system 10 may, additionally or alternatively, comprise a seventh sensor 700. Seventh sensor 700 may comprise at least one radio-frequency identification (RFID) device 702. RFID device 702 may comprise a first component 702A and a second component 702B. In an embodiment, first component 702A and second component 702B may comprise RFID tags and/or readers.

RFID device 702 may be configured with a predetermined range in which first component 702A is capable of communicating with second component 702B. The predetermined range may correspond to an expected maximum distance that connector 26 is expected to be from charging station 12 (e.g., about the length of cable 20). In the event that connector 26 is beyond the range of RFID device 702 (e.g., if cable 20 is severed, damaged, and/or cut), seventh sensor 700 and/or ECU 18 may be configured to determine that active component 702A and passive component 702B are not within range of each other, and detect a disconnection. In an embodiment, second component 702B may be disposed in connector 26 and first component 702A may be disposed in station 12. If cable 20 is removed or stolen, seventh sensor 700 may be configured to detect the removal or theft if second component 702B moves beyond the maximum range and cannot communicate with first component 702A.

As generally illustrated in FIG. 7B, in an embodiment, second component 702B may be disposed in connector 26 and system 10 may provide energy to second component 702B, which may be via cable 20. During normal operation, first component 702A, which may be disposed in station 12, may communicate with second component 702B. In the event of a tampering, second component 702B may not receive energy via cable 20 and may be prevented from communicating with first component 702A. ECU 18 and/or seventh sensor 700 may be configured to monitor RFID device 702 and detect a tampering if first component 702A and second component 702B are not communicating with each other for a threshold amount of time. For example, and without limitation, seventh sensor 700 may include a detector 704 configured to monitor, sensor, and/or detect a loss of connection between first component 702A and second component 702B. In an embodiment, the threshold amount of time may be configured to allow brief lapses in communication, which may prevent at least some false alarms. In other embodiments, the threshold amount of time may be configured such that any lapse in communication, regardless of duration, indicates a tampering (e.g., the threshold time may be set to zero).

In an embodiment, system 10 may be configured with one or more of the sensors described herein and may be configured with any number and/or any combination of the first, second, third, and fourth sensors, fifth, sixth, and seventh sensors 100, 200, 300, 400, 500, 600, 700.

FIG. 8 generally illustrates a flow chart for an alarm system 60 according to an embodiment. ECU 18 may include at least a portion of alarm system 60, or alarm system 60 may be separate from ECU 18, and may or may not be connected to ECU 18. Alarm system 60 may be connected to one or more of the sensors 100, 200, 300, 400, 500, 600, 700 which may be via ECU 18. Alarm system 60 may include logic that may be configured to determine if and how to respond if one or more of the sensors 100, 200, 300, 400, 500, 600, 700 detects a change—e.g., a tampering, disconnection, or theft associated with a charging cable 20. In embodiments, the logic may be relatively simple, with alarm system 60 initiating some kind of action, such as an alarm, when one of the sensors activates (e.g., detects a tampering).

For example, and without limitation, alarm system 60 may receive input 62 from the sensors 100, 200, 300, 400, 500, 600, 700 and/or ECU 18. A monitoring step 64 may monitor input 62 for any detected tampering. If no tampering is detected, alarm system may remain in monitoring step 64. If a tampering is detected in a tampering detection step 65, alarm system 60 may transition to a threshold checking step 66, which may determine if the detected tampering should be verified for a threshold amount of time. For example, a detected tampering from fourth sensor 400 may be verified for connection threshold time. If verifying the detected tampering is not desired, alarm system may transition to an initiate alert step 70. If it is desirable to verify the detected tampering, alarm system may transition to a delay step 68.

Delay step 68 may include a waiting a specified delay time that may be adjustable and/or may be adjusted to correspond to a particular sensor or sensors. Alert active step 69 may detect whether the detected tampering continues to be detected for the specified delay time. If the tampering continues to be detected, alarm system 60 may transition to initiate alert step 70. If the detected tampering does not continue to be detected for the specified time delay (e.g., if cable 20 is reconnected), alarm system may return to monitor step 64.

Initiate alert step 70 may activate a visual alert 80, activate an audible alert 82, and/or transmit an alert signal 84. Visual alert 80 may include at least one light 81 which may be a strobe light. Audible alert 82 may include a horn 83 and/or a siren. Transmitting an alert signal step 84 may include a communication device 85 transmitting an alert signal to a remote monitoring station 86, which may be monitoring service 88.

Additionally or alternatively, system 10 may include a camera 90. Camera 90 may be configured to take photographs and/or record video of an area at or near system 10. Alarm system 60 may include a camera step 92, in which alarm system 60 and/or ECU 18 may be configured to cause camera 90 to take at least one photograph and/or record video. The photo or recording may be further sent by wire or wirelessly to another location for safe receipt, archival, and or attention.

Alarm system 60 may include a camera step 92 and/or an alarm check step 94. Alarm system 60 may transition to camera step 92 if a tampering is detected. Camera step 92 may include taking at least one picture and/or recording video at or near system 10, which may include taking at least one picture and/or recording video of a potential source of the detected tampering (e.g., by a vandal or thief).

Alarm system 60 may transition to alarm check step 94 to check if a detected tampering was cleared, for example, if a threshold time was not exceeded or if a disconnection was reconnected. If the detected tampering was not cleared, at least one picture and/or recorded video, if any, may be saved in save image/recording step 95 to a memory device 98 and/or transmitted to a remote monitoring station 86. If the detected tampering was cleared, at least some of the pictures and/or video may be tagged or discarded in discard step 96.

Additionally or alternatively, more sophisticated logic may be desired. For example, the logic may be designed so that different actions are taken depending on, for example, which sensor is activated, which combination of sensors are activated, charger status (e.g., idle or charging), and/or environmental conditions.

Depending on the specific logic used in the system 10, alarm system 60 may initiate different actions. For example, a strobe light 80 and/or a horn 82 may be connected to alarm system 60 to provide a visual and/or audible alert when charging cable 20 has been tampered with. Alternatively or in addition, alarm system 60 may send a signal to a remote monitoring station 86 via radio, wired, wireless, and/or other communication. Moreover, ECU 18 may activate a camera 90, for example, without limitation, a still camera, video recorder, or webcam, to obtain visual evidence of the thieves. Any or all of these actions may be implemented depending on charging station's 12 environment, a desired theft deterrent effect, and/or a desired type of recordkeeping.

It will be appreciated that the above teachings are merely exemplary in nature and is not intended to limit the present teachings, their application or uses. While specific examples have been described in the specification and illustrated in the drawings, it will be understood by those of ordinary skill in the art that various changes may be made and equivalents may be substituted for elements thereof without departing from the scope of the present teachings as defined in the claims. For example, and without limitation, it should be understood that references to tampering, theft, disconnection, cutting, and/or severing are intended to include each of the others and any condition of system 10 in which cable 20 and/or connector 26 have been altered. Moreover, a resistive element (e.g., resistive element 50A-50F) may include one or more electrical components, alone and/or in combination, that may provide a resistance and/or an impedance, such as, without limitation, resistors, capacitors, inductors, transistors, and/or diodes.

Furthermore, the mixing and matching of features, elements and/or functions between various examples is expressly contemplated herein so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present teachings not be limited to the particular examples illustrated by the drawings and described in the specification as the best mode presently contemplated for carrying out the teachings of the present disclosure, but that the scope of the present disclosure will include any embodiments falling within the foregoing description and the appended claims.

What is claimed:

1. A system for an electric vehicle charging station having a charging cable, comprising:
a charging cable;
a connector coupled to the charging cable;
an ECU disposed in the charging station;
at least one sensor configured to detect tampering with the charging cable; and
an alert system configured to provide an alert corresponding to the at least one sensor detecting a tampering.

2. The system of claim 1, including a coupling connecting the charging cable to the charging station, wherein the at least one sensor includes a switch disposed in the coupling.

3. The system of claim 2, wherein the coupling is a quick-disconnect coupling.

4. The system of claim 1, wherein the at least one sensor is configured to monitor an electrical characteristic of the system.

5. The system of claim 4, wherein the at least one sensor is configured to provide an electrical current to at least one conductor of the charging cable.

6. The system of claim 4, wherein the at least one sensor is configured to monitor a current flowing through one or more conductors of the charging cable.

7. The system of claim 4, including an electrical conversion device including at least one rectifier and at least one filter.

8. The system of claim 1, wherein the at least one sensor includes a holster.

9. The system of claim 8, wherein the holster includes at least one resistive element.

10. The system of claim 1, wherein the at least one sensor comprises a signal transceiver configured to send a signal through the charging cable.

11. The system of claim 10, wherein at least one of the ECU and the at least one sensor is configured to detect an impulse reflection time.

12. The system of claim 11, wherein at least one of the ECU and the alarm system is configured to monitor the impulse reflection time and generate an alert when the impulse reflection time is outside of an expected range.

13. The system of claim 10, wherein the signal transceiver comprises a time domain reflectometer.

14. The system of claim 1, wherein the at least one sensor includes a communication device disposed in the connector.

15. The system of claim 14, wherein the communication device includes at least one wireless transmitter.

16. The system of claim 15, wherein the at least one wireless transmitter includes a cellular transmitter.

17. The system of claim 14, wherein the at least one sensor includes a GPS device.

18. The system of claim 1, wherein the at least one sensor includes an RFID device at least partially disposed in the connector.

19. The system of claim 1, wherein the alert includes at least one of an audible alert, a visual alert, and an alert signal transmitted to a remote location.

20. The system of claim 1, including a camera configured to take at least one picture and/or record video of an area at or near the system.
